(19) United States
(12) Patent Application Publication
(10) Pub. No.: US 2006/0271655 A1
(43) Pub. Date: Nov. 30, 2006

(54) Intelligent traffic management system for networks and intelligent traffic management method using the same

(75) Inventors: Kijoo Yoon, Seoul (KR); Namyeol Lee, Daejoen (KR)

Correspondence Address: LAHIVE & COCKFIELD, 28 STATE STREET, BOSTON, MA, 02109, US

(73) Assignee: NITGEN TECHNOLOGIES Co., Ltd., Seocho-gu (KR)

(21) Appl. No.: 10/557,855

(22) PCT Filed: Dec. 3, 2003
(86) PCT No.: PCT/KR03/02638

§ 371 Date: Nov. 21, 2005

(30) Foreign Application Priority Data
May 21, 2003 (KR) 1020030032414

(51) Int. Cl. G06F 15/173

(52) U.S. Cl. 709/223

(57) ABSTRACT

Disclosed herein is an intelligent traffic management system and an intelligent traffic management method using the intelligent traffic management system. The intelligent traffic management system includes a plurality of Global Load Balance (GLB) agents, a plurality of Server Load Balance (SLB) agents, an Internet traffic management server, and a user terminal. The GLB agents are each provided in a GLB agent dedicated server located in each Point Of Presence (POP) to generate global load balancing information. The SLB agents are each provided in a service server located in the POP to collect server load balancing information at regular intervals. The Internet traffic management server controls and manages POPs distributed over a wide area, and searches for an optimal POP and an optimal service server. The user terminal includes a domain Database (DB) and a client agent program.

### TECHNICAL FIELD

The present invention relates generally to an intelligent traffic management system for networks and an intelligent traffic management method using the intelligent traffic management system. In particularly, the present invention relates to an intelligent traffic management system for networks and an intelligent traffic management method using the intelligent traffic management system, which select one service server having an optimal connection path to a user from service servers located in a plurality of Internet data centers requested by the user and control a user terminal to be connected to the selected service server.

### BACKGROUND ART

FIG. 1 is a schematic configuration diagram of a conventional system required to assign a connection path between a user terminal and a service server through a domain name server.

As shown in the drawing, the system includes a user terminal 1 to request connection to a specific server using domain name information, a Domain Name Server (DNS) connected to the user terminal 1 to convert the domain name information transmitted from the user terminal 1 into an Internet Protocol (IP) address in a resolving manner and transmit the converted IP address to the user terminal 1, and a service server 4 to be connected to the user terminal 1 based on the information of the transmitted IP address.

The DNS 3 is a server that controls the connection of the user terminal 1 to a collection of service servers 4 located in an Internet data center or collections of service servers 4 located in a certain area.

An Internet portal site is an Internet site that is operated in such a way as to provide information search and community services and acquire regular visitors(registered members). Some of popular portal sites would include “Daum,” “Yahoo,” “Naver” and “Lycos.” Since the number of members who have registered at each portal site is enormous as it amounts to a minimum of several hundred thousand and to a maximum of several million, several ten to several hundred servers are located and managed in the Internet data centers so as to allow an enormous number of regular visitors to be connected to the portal site without hindrance.

In the case where such an enormous number of servers are managed by a single Internet data center, a problem arises in that all visitors having registered at a portal site cannot access the portal site when it is not possible to operate the Internet data center due to an internal cause associated with hardware or software, and an external cause such as a power failure. To overcome the above problem, several hundred servers are distributed over various areas and are independently managed by various Internet data centers.

If, in the case of a small-sized web site operated by a small number of servers, for example, three or four servers, servers are managed in various areas, like a large-sized portal site, excessive maintenance costs are incurred. Accordingly, in this case, various servers are usually managed in a single Internet data center. The DNS 3 is installed in the Internet data center to transmit IP address information to the user terminal 1 so that the user terminal 1 can connect to the service server 4 that the user terminal 1 requests.

A conventional method of the DNS 3 assigning a connection path to allow the service server 4 to be connected to the user terminal 1 when the user terminal 1 requests the service server 4 is described below.

The user activates a web browser provided in the user terminal 1 to be connected to the service server 1 through the Internet 2, and enters the domain name of the desired service server 4 in the Uniform Resource Locator (URL) input box of the web browser, thereby transmitting the information of the domain name to the DNS 3.

At that time, the DNS 3 controls the information of the domain name in a resolving manner so that a plurality of user terminals are sequentially and equally connected to the a plurality of service servers, and transmits the IP address information of a sequentially selected service server 4 to a user terminal 1 so that the user terminal 1 can connect to the service server 4 and view web pages.

In the conventional Internet connection path system and method using a domain name server, when the system and method assign a connection path between a user terminal and a service server, a DNS unconditionally connects the user terminal to a service server sequentially selected from a plurality of service servers located in an Internet data center in which a service server requested by a user is located. Accordingly, in the case where the rate of use of system resources, such as the CPU and memory of the connected service server, is high or the number of sessions for each port is large, considerable display delay occurs in the output of web pages operated by the selected service server. Furthermore, in the case where the connected service server has a hardware or software defect, the user terminal cannot be connected to the selected service server so that the user cannot view the web pages, and the user should request connection to the service server having been requested by the user again. These problems become serious for portal sites having a large number of regular visitors.

In other words, the conventional DNS provides the distribution of loads based on a round robin method in which users are assigned to service servers without respect to conditions that directly influence Quality of Service (QoS), such as a hop between a user terminal and a service server or the conditions of the service server. As a result, the conventional load distribution scheme based on the round robin method is disadvantageous in that it cannot provide a high quality service and no connection may be provided to the user because server condition information about the congestion of traffic, increases in the load of the CPU and memory and hardware defects cannot be foreseen.

Furthermore, the conventional load distribution scheme is disadvantageous in that the construction costs of a system are additionally required due to an increase in the number of servers resulting from an increase in simultaneous traffic for multimedia content-oriented Internet services.

To overcome the above-described problems, a server load balancing device called a layer 4 switch (hereinafter referred to as a “L4”) has been proposed. The L4 is a hardware device that is installed in front of a certain number of service servers to analyze packets (data unit including a destination address, etc.) transmitted from a user and to control a user terminal to be connected to an optimal service server having a smallest number of sessions for each port.

Since the L4 selects the optimal service server in view of only the number of sessions for each port with respect to the service server, the difference between data rates caused when the specifications of system resources, such as the CPUs and memories of service servers, are different cannot be taken into account. Accordingly, the L4 is problematic in that it cannot perform the server load balancing function of controlling the user terminal to be connected to an actually optimal service server.

Furthermore, since the L4 is a hardware device, overload occurs when the number of packets requesting connection to service servers is increased, so that the L4 acts as a bottleneck, thus rapidly deteriorating QoS. Accordingly, since the number of L4s must be increased whenever the number of service servers is increased, the construction of additional systems and great expenses due to this system construction are incurred.

### DISCLOSURE OF THE INVENTION

Accordingly, the present invention has been made keeping in mind the above problems occurring in the prior art, and an object of the present invention is to provide an intelligent traffic management system for networks and an intelligent traffic management method using the intelligent traffic management system, which, if a service server requested by a user corresponds to a plurality of service servers located in a plurality of Internet data centers, select an optimal Internet data center in view of hops and packet Internet groper response times with respect to Point Of Presences (POPs), compare and analyze the system resources and hardware and software defect conditions of a plurality of service servers located in the selected optimal Internet data center, and allow a user terminal to be connected to one of the second plurality of service servers having an optimal connection path.

Another object of the present invention is to provide an intelligent traffic management system for networks and an intelligent traffic management method using the intelligent traffic management system, which allow information about system resources and the number of sessions for each port to be transmitted by a SLB installed on each service server, so that the construction of an additional system used to select an optimal service server is not necessary, thus reducing expenses due to the construction of the addition system.

In order to accomplish the above object, the present invention provides an intelligent traffic management system, comprising a plurality of Global Load Balance (GLB) agents each provided in each GLB agent dedicated server located in a Point Of Presence (POP) to generate global load balancing information obtained by calculating a hop and packet Internet groper response time between a user terminal and the POP using Internet Protocol (IP) address information of the user terminal; a plurality of Server Load Balance (SLB) agents each provided in each service server located in the POP to collect server load balancing information including system resource information of the service server and information about the number of sessions for each port at regular intervals; an Internet traffic management server for controlling and managing POPs distributed over a wide area, and searching for an optimal POP and an optimal service server using the global load balancing information and server load balancing information input through control of operation of the GLB agent and the SLB agent so as to establish an optimal connection path between the user terminal and the service server; and the user terminal including a domain Database (DB) for storing domain information of the service server and IP information of the traffic management server controlling and managing the service server, and a client agent program for extracting domain information of the service server requested by a user and IP address information of a corresponding traffic management server and controlling a service server connection request signal including the extracted domain information to be transmitted to the traffic management server having the IP address information of the corresponding traffic management server over an Internet.

The POP is one of a collection of servers located in an Internet data center and a collection of servers located in a certain area.

The traffic management server includes a GLB master for receiving the hops and the packet Internet groper response times, which are the global load balancing information, generated by controlling the GLB agents to be operated through the transmission of the service server connection request signal, comparing and analyzing the hops and the packet Internet groper response times, and selecting the optimal POP; a SLB master for receiving the system resource information and secession information of service servers, which are the server load balancing information, collected by controlling the SLB agents of the service servers to be operated through the transmission of the service server connection request signals, comparing and analyzing the system resource information and secession information, and selecting the optimal service server; a communication module for performing an interface function to enable data transmission/reception between the servers and the agents; a Database (DB) for storing fixed IP block information about the optimal POP matched with the user terminal preset by a system manager, the domain and IP information of the service server requested by the user, optimal global load balancing information including server connection request time information about the time when the user requests connection to the service server and the IP address information of the user terminal, and values obtained by calculating the hop and the packet Internet groper response time between the user terminal and the optimal POP, and server load balancing information of each service server located in each POP; and a control unit for controlling operations of the GLB master and SLB master.

The server load balancing information stored in the DB is updated by service load balancing information automatically transmitted from each service server provided with the SLB agent located in each POP at regular intervals.

The intelligent traffic management system further comprises a user terminal that is not provided with the client agent program.

The intelligent traffic management system further comprises a Domain Name Server (DNS) for storing the IP address information of the traffic management server, wherein, when the service server connection request signal is transmitted from the user terminal not provided with the client agent program to the DNS, the DNS adds IP address information thereof to the service server connection request signal, and transmits the service server connection request signal together with the IP address information of the DNS.

The service server connection request signal transmitted from the user terminal not provided with the client agent program to the DNS comprises the domain information of the service server requested by the user.

When the user terminal not provided with the client agent program requests a connection path to the service server, the GLB agent generates the global load balancing information obtained by calculating the hop and the packet Internet groper response time between the user terminal and each POP using the IP address information of the DNS.

When the user terminal not provided with the client agent program requests a connection path to the service server, the DB stores the fixed IP block information about the optimal POP matched with the user terminal preset by a system manager, the domain and IP information of the service server requested by the user, the optimal global load balancing information including server connection request time information about the time when the user requests connection to the service server and the IP address information of the user terminal, and the values obtained by calculating the hop and the packet Internet groper response time between the user terminal and the optimal POP, and the server load balancing information of each service server located in each POP.

The system resource information contained in the server load balancing information is information about the Central Processing Unit (CPU) and memory of the service server.

In the global load balancing information, the hop refers to a path through which a single packet is transmitted from a router to another router on a packet-switched network. It can be appreciated that, as the hop becomes longer, the transmission/reception time is increased between the client and the server. Accordingly, the optimal POP can be selected by comparing and analyzing the time.

In the global load balancing information, the packet Internet groper response time refers to information capable of determining whether there is a certain Internet address and the Internet address can receive a request. Accordingly, the optimal POP can be selected by comparing and analyzing the packet Internet groper response time.

The user terminals include typical desktop computers (including notebook computers and personal digital assistants) that are capable of performing an Internet access, or dedicated terminals to which application programs are installed to use particular services, such as a stock trade. Accordingly, the web browser includes one of web browsers used in a desktop environment, or one of dedicated web browsers used in the dedicated terminals.

In addition, the present invention provides an intelligent traffic management method, including the step of running a web browser installed on a user terminal to connect the user terminal to a service server through an optimal connection path; the step of determining whether a client agent program is installed; the step of, if the client agent program is installed, extracting domain name information of the requested service server, IP address information of a corresponding traffic management server managing and controlling the service server, and IP address information of the user terminal; the step of transmitting a service server connection request signal including the extracted information to the corresponding traffic management server; the step of determining whether the user terminal corresponds to a fixed IP block set by a system manager; the step of, if the user terminal does not correspond to the fixed IP block, determining whether global balancing information matched with the IP address of the user terminal exists; the step of, if the global balancing information exists, selecting an optimal POP using the global balancing information; the step of searching for an optimal one of service servers located in the selected optimal POP; and the step of assigning an optimal connection path by transmitting the IP address of the searched optimal service server to the user terminal.

The intelligent traffic management method further comprises the step of, if the user terminal corresponds to the fixed IP block at the step of determining whether the user terminal corresponds to the fixed IP block, extracting a previously set optimal POP.

At the step of determining whether the user terminal corresponds to the fixed IP block, the fixed IP block is one of IP addresses of service servers used by an Internet Service Provider (ISP) at which the user has registered to use a Internet service and IP addresses of servers located in an Internet data center for each area.

At the step of determining whether the global load balancing information matching the IP address information of the user terminal exists, the DP address of the user terminal is used to determine whether the global load balancing information exists through matching with the server connection request time information stored in the DB of the traffic management server.

At the step of searching for an optimal one of service servers located in the selected optimal POP, the searching for the optimal service server is performed by comparing and analyzing server load balancing information comprising system resource information including information about the CPU and memory of each service server and information about the number of sessions for each port in the server load balancing information of the service servers located in each POP, which is stored in the DB of the traffic management server, searching for one service server having optimal service load balancing information, and selecting the service server having an optimal connection path to the user terminal.

The step of selecting an optimal POP using the global balancing information comprises the step of reading recent connection time when the user requests connection to the service server; the step of determining whether an available period of the global balancing information is terminated; the step of, if the available period of the global balancing information is terminated, extracting an optimal POP by controlling the GLB agent.

If the available period of the global balancing information is not terminated, the intelligent traffic management method further comprises the step of selecting global load balancing information indicating the optimal POP.

The step of extracting an optimal POP by controlling the GLB agent comprises the step of transmitting IP address information of the user terminal from the traffic management server to a GLB agent dedicated server provided with the GLB agent in each POP; the step of generating new global load balancing information obtained by calculating a hop and packet Internet groper response time between the user terminal and the POP using the transmitted IP address information of the user terminal and transmitting the new global load balancing information; and the step of comparing and analyzing plural pieces of new global load balancing information transmitted from respective POPs, and selecting and storing an optimal POP.

At the step of comparing and analyzing plural pieces of new global load balancing information transmitted from respective POPs, and selecting and storing an optimal POP, server connection request time information including time when the user requests connection to a corresponding service server and the IP address information of the corresponding user terminal is attached to the new global load balancing information and the new global load balancing information together with server connection request time information is stored in the DB.

If the client agent program is not installed on the user terminal at the step of determining whether the client agent program is installed on the user terminal, the intelligent traffic management method further comprises the step of extracting domain name information of a service server requested by the user terminal on which the client agent program is not installed; the step of transmitting the extracted domain name information of the service server to the DNS; the step of determining whether the DNS has IP address information of the traffic management server; and the step of, if the DNS has the IP address information of the traffic management server, transmitting the server connection request signal in which the IP address information address of the DNS is attached to the domain name information of the service server to the traffic management server.

At the step of determining whether the user terminal corresponds to the fixed IP block set by the system manager, it is determined whether the user terminal corresponds to the fixed IP block using one of the IP address information of the user terminal and the IP address information of the DNS.

At the step of, if the user terminal does not correspond to the fixed IP block, determining whether global balancing information matched with the IP address of the user terminal exists, if the user terminal not provided with the client agent program requests connection to a service server, it is determined whether the global load balancing information exists by matching with the IP address information of the corresponding DNS.

The IP address information of the DNS is used to determine whether the global load balancing information exists through matching with the server connection request time information stored in the DB of the traffic management server.

At the step of searching for the optimal one of service servers located in the selected optimal POP, if the user terminal not provided with the client agent program requests connection to the service server, the searching for the optimal service server is performed by comparing and analyzing the server load balancing information comprising the system resource information including information about the CPU and memory of each service server and information about the number of sessions for each port in the server load balancing information of the service servers located in each POP, which is stored in the DB of the traffic management server, searching for one service server having optimal service load balancing information, and selecting the service server having an optimal connection path to the user terminal.

At the step of generating new global load balancing information obtained by calculating a hop and packet Internet groper response time between the user terminal and the POP using the transmitted IP address information of the user terminal and transmitting the new global load balancing information, if the user terminal not provided with the client agent program requests connection to the service server, the new global load balancing information obtained by calculating the hop and the packet Internet groper response time between the user terminal and each POP using the IP address information of the DNS is generated.

At the step of comparing and analyzing plural pieces of new global load balancing information transmitted from respective POPs and selecting and storing an optimal POP, if the user terminal not provided with the client agent program requests connection to the service server, the server connection request time information including time when the user requests connection to a corresponding service server and the IP address information of the corresponding DNS is attached to the new global load balancing information and the new global load balancing information together with server connection request time information is stored in the DB.

In addition, the present invention provides an intelligent traffic management method, comprising the step of running a web browser installed on a user terminal to connect the user terminal to a service server through an optimal connection path when the service server requested by a user is located in a single POP; the step of determining whether a client agent program is installed; the step of, if the client agent program is installed, extracting domain name information of the requested service server, IP address information of a corresponding traffic management server managing and controlling the requested service server, and IP address information of the user terminal; the step of transmitting a service server connection request signal including the extracted information to the corresponding traffic management server; the step of determining whether the service server requested by the user is located in the single POP; the step of, if the service server requested by the user is located in the single POP, searching for an optimal service server in the corresponding POP; and the step of assigning an optimal connection path by transmitting the IP address of the searched optimal service server to the user terminal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic configuration diagram of a conventional system required to assign a connection path between a user terminal and a service server through a domain name server;

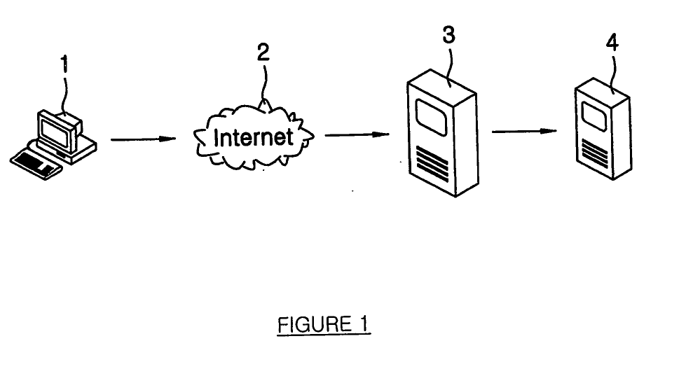

FIG. 2 is a system configuration diagram of an intelligent traffic management system according to the present invention;

FIG. 3 is a detailed block diagram of a traffic management server of FIG. 2;

FIG. 4 is a flowchart showing an intelligent traffic management method using the traffic management system according to the present invention;

FIG. 5 is a flowchart showing a process of entering step “A” if the client agent program is not installed as the result of the determination at the step S200 of determining whether the client agent program is installed as shown in FIG. 4;

FIG. 6 is a detailed flowchart showing the step S700 of selecting the optimal POP using the global load balancing information as shown in FIG. 4;

FIG. 7 is a detailed flowchart showing the step S730 of selecting an optimal POP by controlling the global load balance agent as shown in FIG. 6; and

FIG. 8 is a flowchart showing another intelligent traffic management method using the intelligent traffic management system in the case where a service server requested by the user corresponds to a site operated on a small scale, which is another embodiment of the present invention.

### BEST MODE FOR CARRYING OUT THE INVENTION

A preferred embodiment of the present invention is described with reference to the accompanying drawings hereinafter. In the drawings, the same reference numerals are used throughout the different drawings to designate the same or similar components.

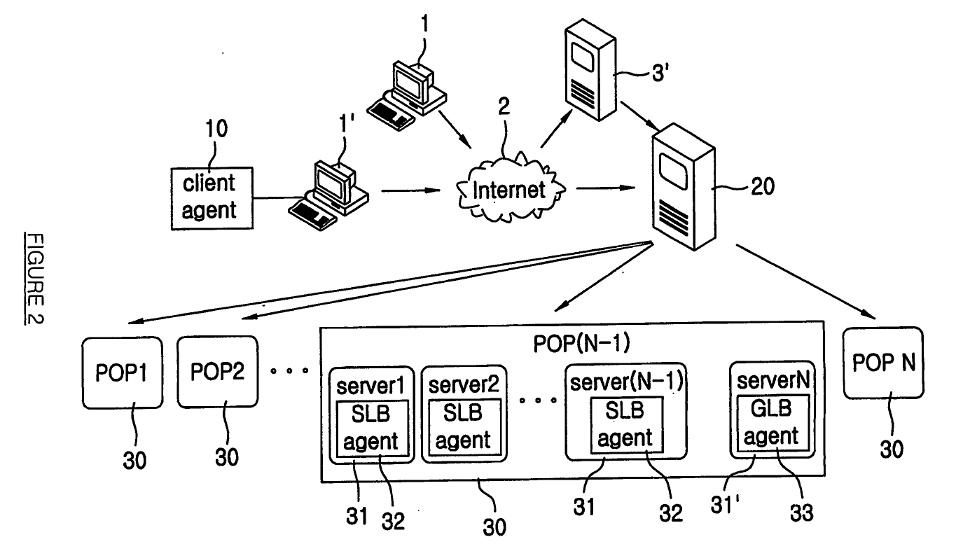

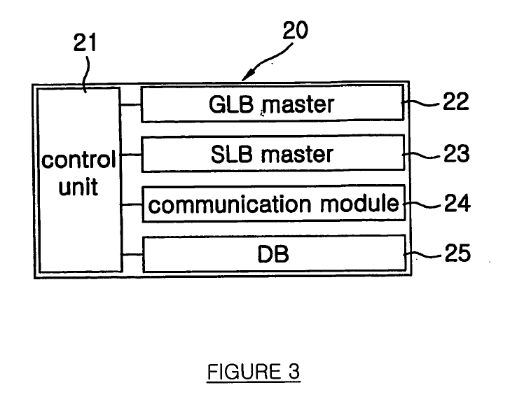

FIG. 2 is a system configuration diagram of an intelligent traffic management system according to the present invention. FIG. 3 is a detailed block diagram of a traffic management server of FIG. 2.

The intelligent traffic management system of the present invention includes a plurality of Global Load Balance (GLB) agents 33, a plurality of Server Load Balance (SLB) agents 32, an Internet traffic management server, and a user terminal 1′.

The plurality of GLB agents 33 are each provided in a GLB agent dedicated server 31′ located in each POP 30 to generate global load balancing information obtained by calculating a hop and packet Internet groper response time between the user terminal 1′ and the POP 30 using the Internet Protocol (IP) address of the user terminal 1′. The plurality of SLB agents 32 are each provided in each service server 31 located in the POP 30 to collect server load balancing information including the system resource information of the service server 31 and information about the number of sessions for each port at regular intervals. The Internet traffic management server controls and manages POPs 30 distributed over a wide area, and searches for an optimal POP 30 and an optimal service server 31 using the global load balancing information and the server load balancing information input through the control of operation of the GLB agent 33 and the SLB agent 31 so as to establish an optimal connection path between the user terminal 1′ and the service server 31. The user terminal 1′ includes a domain Database (DB, not shown) for storing the domain information of the service server 31 and the IP information of the traffic management server 20 controlling and managing the service server 31, and is provided with a client agent program 10 for extracting the domain information of the service server 31 requested by a user and the IP address information of a corresponding traffic management server 20 and controlling a service server connection request signal including the extracted domain information to be transmitted to the traffic management server 20 having the IP address information of the corresponding traffic management server 20 over the Internet 2.

The POP 30 is one of a collection of servers located in an Internet data center and a collection of servers located in a certain area.

The traffic management server 20 includes a GLB master 22, a SLB master 23, a communication module 24, a Database (DB) 25, and a control unit 21.

The GLB master 22 receives the hops and the packet Internet groper response times, which are the global load balancing information, generated by controlling the GLB agents 33 to be operated through the transmission of the service server connection request signal, compares and analyzes the hops and the packet Internet groper response times, and selects the optimal POP 30. The SLB master 23 receives the system resource information and secession information of service servers, which are the server load balancing information, collected by controlling the SLB agents 33 of the service servers 31 to be operated through the transmission of the service server connection request signals, compares and analyzes the system resource information and secession information, and selects the optimal service server 31. The communication module 24 performs an interface function to enable data transmission/reception between the servers 31 and 31′ and the agents 32 and 33. The DB 25 stores fixed IP block information about the optimal POP 30 matched with the user terminal 1′ and preset by a system manager, the domain and IP information of the service server 31 requested by the user, optimal global load balancing information including server connection request time information about the time when the user requests connection to the service server and the IP address information of the user terminal 1′, and values obtained by calculating the hop and the packet Internet groper response time between the user terminal 1′ and the optimal POP 30, and server load balancing information of each service server 31 located in each POP 30.

The control unit 21 controls the operations of the GLB master 22 and SLB master 23.

The server load balancing information stored in the DB 25 is updated by service load balancing information automatically transmitted from each service server 31 provided with the SLB agent 32 located in each POP at regular intervals.

The intelligent traffic management system further includes a user terminal 1 that is not provided with the client agent program 10.

The intelligent traffic management system further includes a DNS 3′ for storing the IP address information of the traffic management server 20. When the service server connection request signal is transmitted from the user terminal 1 not provided with the client agent program 10 to the DNS 3′, the DNS 3′ adds IP address information thereof to the service server connection request signal, and transmits the service server connection request signal together with the IP address information of the DNS 3′.

The service server connection request signal transmitted from the user terminal 1 not provided with the client agent program 10 to the DNS 3′ includes the domain information of the service server 31 requested by the user.

When the user terminal 1 not provided with the client agent program 10 requests a connection path to the service server 31, the GLB agent 33 generates the global load balancing information obtained by calculating the hop and the packet Internet groper response time between the user terminal 1′ and each POP 30 using the IP address information of the DNS 3′.

When the user terminal 1 not provided with the client agent program 10 requests a connection path to the service server 31, the DB 25 The DB 25 stores fixed IP block information about the optimal POP 30 matched with the user terminal 1′ and preset by a system manager, the domain and IP information of the service server 31 requested by the user, optimal global load balancing information including server connection request time information about the time when the user requests connection to the service server and the IP address information of the user terminal 1′, and values obtained by calculating the hop and the packet Internet groper response time between the user terminal 1′ and the optimal POP 30, and server load balancing information of each service server 31 located in each POP 30.

The system resource information contained in the server load balancing information is information about the Central Processing Unit (CPU) and memory of the service server.

In the global load balancing information, the hop refers to a path through which a single packet (the basic transmission unit of data transmitted between a client and a server) is transmitted from a router to another router on a packet-switched network. It can be appreciated that, as the hop becomes longer, the transmission/reception time is increased between the client and the server. Accordingly, the optimal POP 30 can be selected by comparing and analyzing the time.

In the global load balancing information, the packet Internet groper response time refers to information capable of determining whether there is a certain Internet address and the Internet address can receive a request. Accordingly, the optimal POP 30 can be selected by comparing and analyzing the packet Internet groper response time.

The user terminals 1 and 1′ are typical desktop computers (including notebook computers and personal digital assistants) that are capable of performing an Internet access, or dedicated terminals to which application programs are installed to use particular services, such as a stock trade. Accordingly, the web browser is one of web browsers used in a desktop environment, or one of dedicated web browsers used in the dedicated terminals.

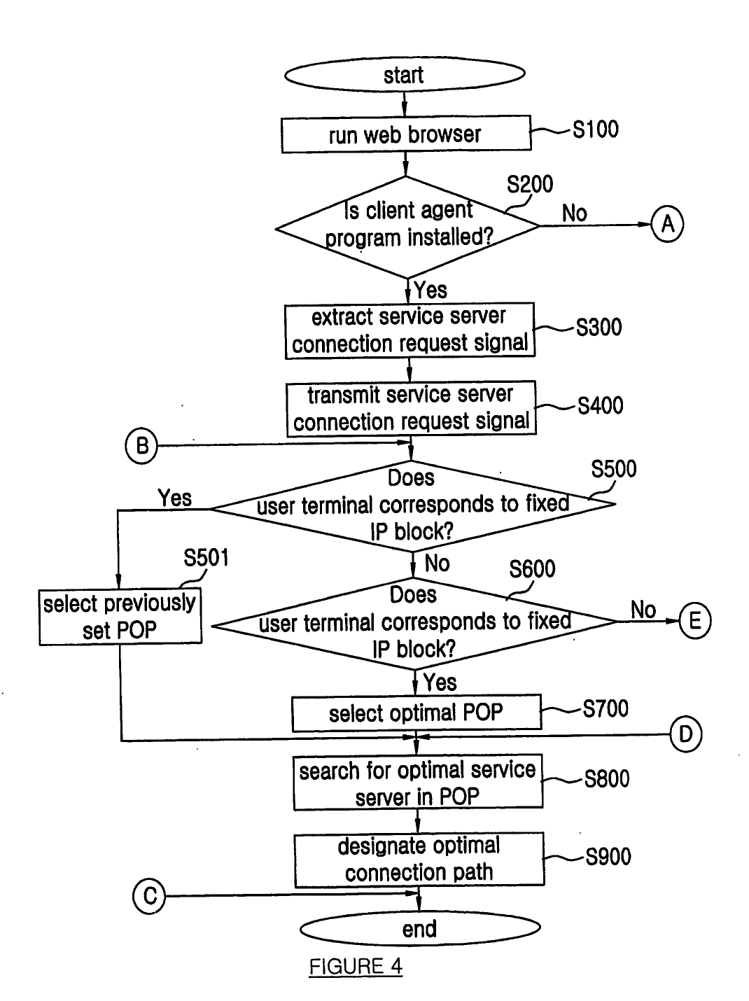

FIG. 4 is a flowchart showing an intelligent traffic management method using the traffic management system according to the present invention.

As shown in the drawing, the intelligent traffic management method includes step S100 to S900. A web browser installed on a user terminal is run to connect the user terminal to a service server through an optimal connection path at the step S100. It is determined whether a client agent program is installed at the step S200. If the client agent program is installed, the domain name information of the requested service server, the IP address information of a corresponding traffic management server managing and controlling the service server, and the IP address information of the user terminal are extracted at the step S300. A service server connection request signal including the extracted information is transmitted to the corresponding traffic management server at the step S40. It is determined whether the user terminal corresponds to a fixed IP block set by a system manager at the step S500. If the user terminal does not correspond to the fixed IP block, it is determined whether global balancing information matched with the IP address of the user terminal exists at the step S600. If the global balancing information exists, an optimal POP is selected using the global balancing information at the step S700. Service servers located in the selected optimal POP are searched for an optimal server at the step S800. An optimal connection path is assigned by transmitting the IP address of the searched optimal service server to the user terminal at the step S900.

If the user terminal corresponds to the fixed IP block as the result of the determination at the step S500 of determining whether the user terminal corresponds to the fixed IP block, a previously set optimal POP is extracted at the step S501, and the process enters the step S800 of searching for an optimal one of service servers located in the selected optimal POP.

The fixed IP block is an IP address of each service server used by an Internet Service Provider (ISP) at which the user has registered to use an Internet service, or an IP address of each service server located in an Internet data center for each area. If the service server requested by the user corresponds to the ISP at which the user registers has registered, the manager of the intelligent traffic management system may set the connection path to the IP address of the ISP without searching for and extracting the optimal POP 30 because the ISP is physically closest.

Additionally, if a plurality of service servers are provided in the Internet data center for each area to allow the user terminal to be connected to the service server through the optimal connection path, the manager of the intelligent traffic management system may select one of the plurality of service servers.

At the step S600 of determining whether the global load balancing information matching the IP address information of the user terminal exists, the IP address of the user terminal is used to determine whether the global load balancing information exists through the matching with the server connection request time information stored in the DB 25 of the traffic management server.

At the step S800 of searching for an optimal one of service servers located in the selected optimal POP, the optimal service server 31 having an optimal connection path to the user terminal 1′ is selected by comparing and analyzing server load balancing information including system resource information about the CPUs and memories of the service servers in each POP 30 and information about the numbers of sessions for ports thereof in the server load balancing information of the service servers 31 located in each POP 30 and stored in the DB 25 of the traffic management server and, thus, searching for the service server 31 having optimal server load balancing information.

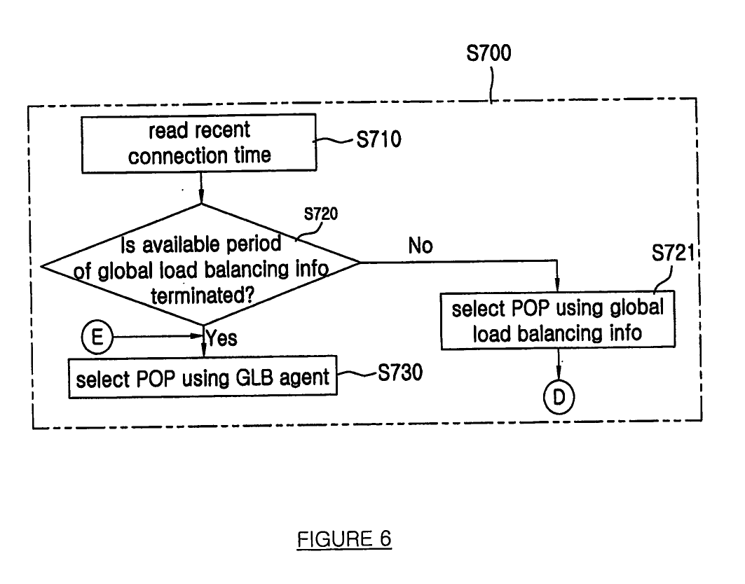

FIG. 6 is a detailed flowchart showing the step S700 of selecting the optimal POP using the global load balancing information as shown in FIG. 4.

As shown in the drawing, the step S700 of selecting an optimal POP using the global balancing information includes the steps S710 to S730. The recent connection time when the user requests connection to the service server is read at the step S710. It is determined whether the available period of the global balancing information is terminated at the step S720. If the available period of the global balancing information is terminated, an optimal POP is extracted by controlling the GLB agent at the step S730.

If the available period of the global balancing information is not terminated at step S720, global load balancing information indicating the optimal POP is selected at the step S721, and the process enters the step S800 of searching service servers located in the extracted optimal POP for an optimal service server.

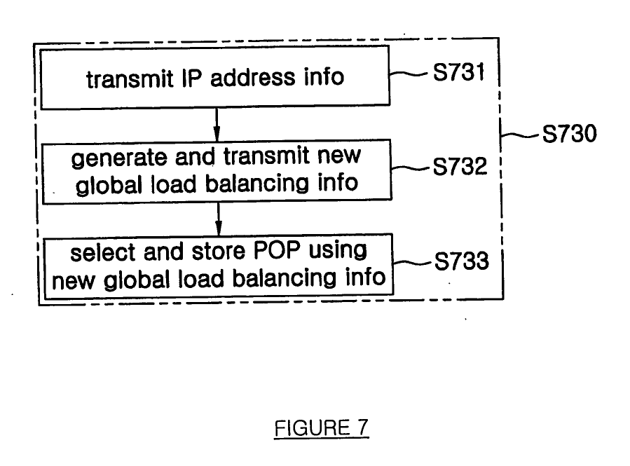

FIG. 7 is a detailed flowchart showing the step S730 of selecting an optimal POP by controlling the GLB agent as shown in FIG. 6.

As shown in the drawing, the step S730 of extracting the optimal POP by controlling the GLB agent includes steps S731 to S733. The IP address information of the user terminal is transmitted from the traffic management server to a GLB agent dedicated server provided with the GLB agent in each POP at the step S731. The new global load balancing information obtained by calculating the hop and the packet Internet groper response time between the user terminal and the POP is generated using the transmitted IP address information of the user terminal, and the new global load balancing information is transmitted at the step S732. Plural pieces of new global load balancing information transmitted from respective POPs are compared and analyzed, and an optimal POP is selected and stored at the step S733.

At the step S733 of comparing and analyzing the plural pieces of new global load balancing information transmitted from respective POPs, and selecting and storing the optimal POP, server connection request time information including time when the user requests connection to a corresponding service server and the IP address information of the corresponding user terminal 1′ is attached to the new global load balancing information and the new global load balancing information together with server connection request time information is stored in the DB.

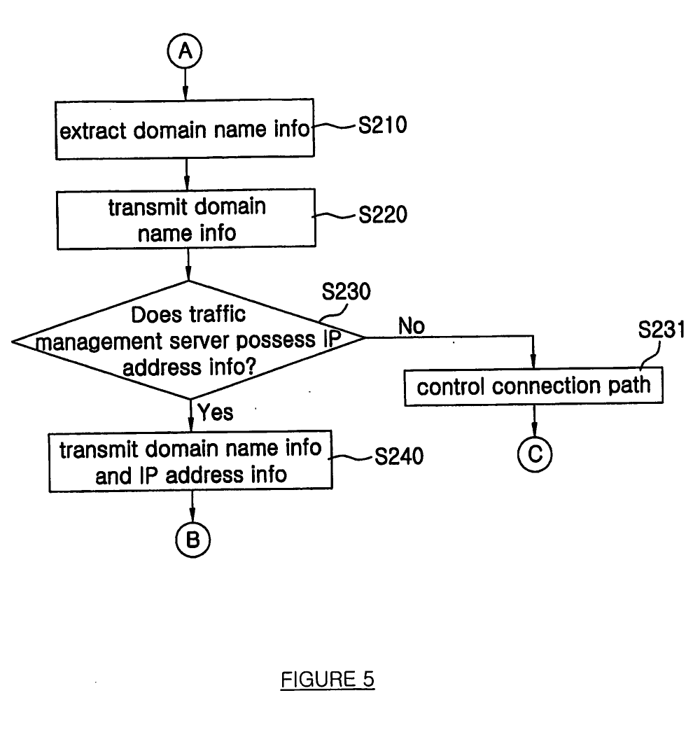

FIG. 5 is a flowchart showing a process of entering step “A” if the client agent program is not installed as the result of the determination at the step S200 of determining whether the client agent program is installed as shown in FIG. 4.

As shown in the drawing, if the client agent program is not installed on the user terminal as the result of the determination at step S200 of determining whether the client agent program is installed on the user terminal, steps S210 to S240 are performed. The domain name information of a service server, which is requested by the user terminal on which the client agent program is not installed, is extracted at the step S210. The extracted domain name information of the service server is transmitted to the DNS at the step S220. It is determined whether the DNS has the IP address information of the traffic management server at the step S230. At the step S240, if the DNS has the IP address information of the traffic management server, the server connection request signal in which the IP address information address of the DNS is attached to the domain name information of the service server is transmitted to the traffic management server, and the process enters the step S500 of determining whether the user terminal corresponds to the fixed IP block set by the system manager.

If the DNS does not have the IP address information of the traffic management server at the step S230 of determining whether the DNS has IP address information of the traffic management server, the DNS controls the user terminal to be connected to the service server at the step S231, and the process ends.

At the step S500 of determining whether the user terminal corresponds to the fixed IP block set by the system manager, it is determined whether the user terminal corresponds to the fixed IP block using the IP address information of the user terminal or the IP address information of the DNS.

At the step S600 of, if the user terminal does not correspond to the fixed IP block, determining whether global balancing information matched with the IP address of the user terminal exists, if the user terminal not provided with the client agent program requests connection to a service server, it is determined whether the global load balancing information exists by matching with the IP address information of the corresponding DNS.

The IP address information of the DNS is used to determine whether the global load balancing information exists through matching with the server connection request time information stored in the DB 25 of the traffic management server.

At the step S800 of searching for the optimal one of service servers located in the selected optimal POP, if the user terminal not provided with the client agent program requests connection to the service server, the searching for the optimal service server is performed by comparing and analyzing server load balancing information comprising system resource information including information about the CPU and memory of each service server and information about the number of sessions for each port in the server load balancing information of the service servers 31 located in each POP 30, which is stored in the DB 25 of the traffic management server, searching for one service server 31 having optimal service load balancing information, and selecting the service server 31 having an optimal connection path to the user terminal 1′.

At the step S732 of generating new global load balancing information obtained by calculating a hop and packet Internet groper response time between the user terminal and the POP using the transmitted IP address information of the user terminal and transmitting the new global load balancing information, if the user terminal not provided with the client agent program requests connection to the service server, the new global load balancing information obtained by calculating the hop and the packet Internet groper response time between the user terminal 1′ and each POP 30 using the IP address information of the DNS 3′ is generated.

At the step S733 of comparing and analyzing plural pieces of new global load balancing information transmitted from respective POPs and selecting and storing an optimal POP, if the user terminal not provided with the client agent program requests connection to the service server, the server connection request time information including time when the user requests connection to a corresponding service server and the IP address information of the corresponding DNS 3′ is attached to the new global load balancing information and the new global load balancing information together with server connection request time information is stored in the DB.

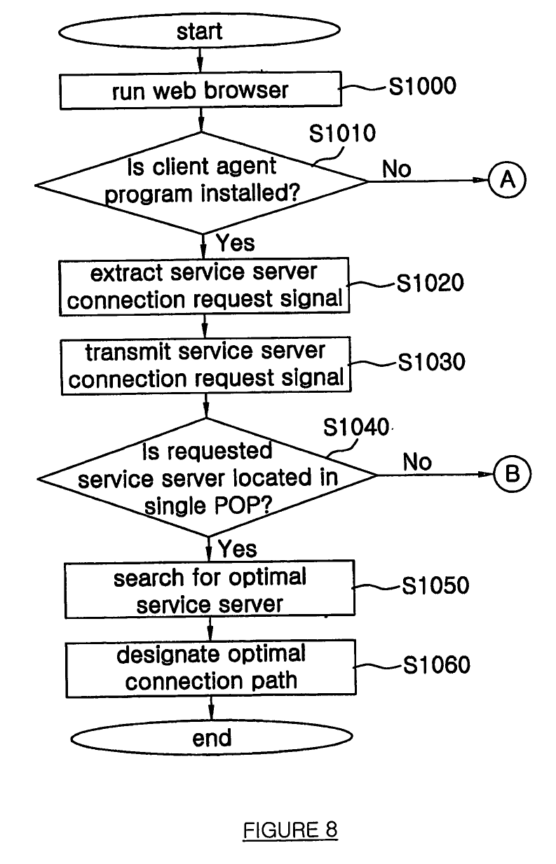

FIG. 8 is a flowchart showing an intelligent traffic management method using the intelligent traffic management system in the case where a service server requested by the user corresponds to a site operated on a small scale, which is another embodiment of the present invention.

As shown in the drawing, the intelligent traffic management method includes steps S1000 to S1060. When the service server requested by a user is located in a single POP, a web browser installed on a user terminal is run to connect the user terminal to a service server through an optimal connection path at the step S1000. It is determined whether a client agent program is installed at the step S1010. If the client agent program is installed, there are extracted the domain name information of the requested service server, the IP address information of a corresponding traffic management server managing and controlling the requested service server, and the IP address information of the user terminal at the step S1020. A service server connection request signal including the extracted information is transmitted to the corresponding traffic management server at the step S1030. It is determined whether the service server requested by the user is located in the single POP at the step S1040. If the service server requested by the user is located in the single POP, an optimal service server in the corresponding POP is searched for at the step S1050. An optimal connection path is assigned by transmitting the IP address of the searched optimal service server to the user terminal at the step S1060.

At the step S1010 of determining whether the client agent program is installed, if the client agent program is not installed, the process enters step “A” of FIG. 5.

At the step S1040 of determining whether the service server requested by the user is located in the signal POP, if the service server is located in various POPs, the process enters step “B” of FIG. 4.

The operations of the embodiments are described with reference to the accompanying drawings below.

The user runs the web browser provided in the user terminal 1 or 1′ through the user terminal 1 or 1′ capable of providing an Internet service to connect with the service server 31, such as “Daum (www.daum.net)” at step S100. In this case, the operation differs depending on whether the client agent program 10 is installed on the user terminal 1 or 1′.

The case where the client agent program 10 is installed on the user terminal 1 or 1′ is described first.

When the user requests connection by entering the domain name of the service server 31 in the URL input box of a web browser window activated by the running of the web browser, the standby client agent program 10 extracts the domain information of the corresponding service server 31 and the IP address information of the traffic management server 20 controlling and managing the service server 31 by matching the domain name information of the service server 31 with the information of the domain DB at step S300, generates a service server connection request signal in which the IP address information of the user terminal 1′ is attached to the extracted domain name information of the service server 31, and transmits the service server connection request signal to the traffic management server 20 having the IP address information of the traffic management server 20 through the Internet 2 at step S400.

As described above, if the client agent program 10 is not installed on the user terminal 1, the domain name information of the domain name server, which is requested by the user terminal 1 in which the client agent program is not installed, is extracted at step S210, the service server connection request signal including the extracted domain name information of the service server is transmitted to the DNS 3′ through the Internet 2, and it is determined whether the DNS 3′ has IP address information of the traffic management server at step S230.

If the DNS 3′ does not have the IP address information of the traffic management server, a connection path between the user terminal 1 and the service server 31 is assigned by a resolving method at step S231. If the DNS 3′ has IP address information of the traffic management server, the DNS 3′ attaches the IP address information thereof to the IP address information of the service server 31 transmitted to the traffic management server 20 and transmits the IP address information thereof together with the IP address information of the service server 31 to the traffic management server 20 having the IP address information of the traffic management server 20 through the Internet 2 at step S240.

The control unit 21 of the traffic management server 20 determines whether the IP address information of the user terminal 1 or 1′ or the DNS 3′ corresponds to the fixed IP block including an optimal POP 30 preset by the system manager by matching the IP address information of the user terminal 1 included in the transmitted service server connection request signal with the information of the DB 25 at step S500. If the service server connection request signal is transmitted from the DNS 3′ (connection to the service server is requested by the user terminal not provided with the client agent program), it is determined whether the IP address information of the user terminal 1 or 1′ or the DNS 3′ corresponds to the fixed IP block including an optimal POP 30 using the, IP address information of the DNS 3′ included in the service server connection request signal at step S500.

If the IP address information of the user terminal 1 or 1′ or the DNS 3′ does not correspond to the fixed IP block, it is determined whether the global load balancing information of the user exists by matching the IP address information of the user terminal 1 or 1′ or the DNS 3′ with the information of the DB 25 at step S600.

If the global load balancing information matching the user terminal 1 or 1′ exists, the step S700 of extracting an optimal POP using the global load balancing information is performed by extracting server connection request time by matching the IP address information of the user terminal 1 or 1′ or the DNS 3′ with the information of the DB 25, reading recent connection time when the user connected the currently requested service server recently, which is included in the extracted server connection request time information, at step S710, and determining whether the available time of the global load balancing information is terminated at step S720.

The purpose for which it is determined whether the available time of the global load balancing information is terminated is to take into account an optimal environment between the user terminal 1 or DNS 3′ and the POP 30 in real time. For example, if a change occurs in the hop or packet Internet groper response time between the user terminal 1 or DNS 3′ included in the global load balancing information, the purpose is to select an optimal POP 30 taking into account the optimal network environment between the user terminal 1 or DNS 3′. To this end, the available time of the global load balancing information is set to 24 hours, and the manager operating the traffic system may change the available time according to the conditions of the network system.

If the available time of the global load balancing information is terminated as the result of the determination, the GLB agent 33 is controlled to extract the optimal POP at step S730. If there is no global load balancing information of the user matched at the step S600 of determining whether the global load balancing information of the user exists by matching the IP address information of the user terminal 1 or DNS 3′ with the information of the DB 25, the process enters the step S730 of extracting the optimal POP by controlling the GLB agent.

The step 730 of extracting the optimal POP by controlling the GLB agent is performed as described below. When the control unit 21 of the traffic management server 20 transmits the IP address information of the user terminal 1 or DNS 3′ to the GLB agent dedicated server 31′ provided with the GLB agent 33 in each POP 30, the standby GLB agent dedicated server 31′ controls the operation of the GLB agent 33 to calculate the hop and the packet Internet groper response time between the user terminal 1 and 1′ and the POP to which the GLB agent dedicated server 31′ belongs, generates the new global load balancing information, and transmits the generated new global load balancing information to the traffic management server 20 at step S732. In this case, when the user terminal 1 not provided with the client agent program requests connection to the service server, the reason why the optimal POP 30 is selected using the IP address information of the DNS 3′ is that the DNS 3′ is physically closest because the DNS 3′ controls and manages the user terminal 1 having requested connection to the service server.

The traffic management server 20 selects an optimal POP 30 by comparing and analyzing plural pieces of new global load balancing information transmitted, attaches a selected piece of new global load balancing information to server connection request time information indicating the time when the user terminal 1 and 1′ requests connection to the corresponding service server 31 to match the user terminal 1′ or DNS 3′ having requested the service server 31 and stores the new global load balancing information together with the server connection request time information in the DB 25 at step S733.

If the available time of the global load balancing information is not terminated as the result of the determination at step S720, the global load balancing information indicating the optimal POP is selected at step S721, and the process enters the step S800 of searching service servers 31 located in the selected optimal POP for the optimal service server 31.

At the step S800 of searching for an optimal service server, the optimal service server 31 having an optimal connection path is selected by comparing and analyzing server load balancing information including system resource information about the CPUs and memories of the service servers in each POP 30 and information about the numbers of sessions for ports thereof in the server load balancing information of the service servers 31 located in each POP 30 and stored in the DB 25 of the traffic management server and, thus, searching for the service server 31 having optimal server load balancing information.

By transmitting the IP address information of a single selected service server 31 to the corresponding user terminal 1 or 1′ through the Internet 2, the user terminal 1 or 1′ is assigned the optimal connection path to the service server 31, and a portal site (web page) requested by the user is displayed on the user terminal 1 or 1′ without delay.

FIG. 8 is a flowchart showing another intelligent traffic management method using the intelligent traffic management system in the case where the service server requested by the user corresponds to a site operated on a small scale, which is another embodiment of the present invention.

Since the steps ranging from the step S1000 of running the web browser provided in the user terminal 1 or 1′ to the step S1030 of transmitting the service server connection request signal to the corresponding traffic management server including the extracted information are the same as described above, descriptions of these steps are omitted here.

In contrast, if the control unit 21 of the traffic management server 20 reads the domain name information of the corresponding service server 20 included in the transmitted service server connection request signal and a corresponding web site is a small-sized web site operated by three or four servers located in a signal Internet data center during the transmission of the service server connection request signal including extracted information to the corresponding traffic management server at step S1030, the optimal service server is searched for in the corresponding POP to select a single service server 31 having the optimal connection path at step S1050, and the IP address information of the single service server is transmitted to the corresponding user terminal 1 or 1′ over the Internet 2 to allow the optimal connection path to the service server 31 to be assigned to the user terminal 1 or 1′ at step S1060.

In that case, the determination in which the corresponding web site is a small-sized web site operated by three or four servers located in a signal Internet data center may be performed by the selection and assignment of the manager of the intelligent traffic management system.

### INDUSTRIAL APPLICABILITY

As described above, the present invention provides an intelligent traffic management system and an intelligent traffic management method, which allow a user terminal to be connected to one of a plurality of service servers having an optimal connection path by comparing and analyzing the system resources and various internal and external defect conditions of the service servers located in a plurality of distributed Internet data centers if a service server requested by a user corresponds to a plurality of service servers located in the plurality of Internet data centers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An intelligent traffic management system, comprising:
a plurality of Global Load Balance (GLB) agents each provided in each GLB agent dedicated server located in a Point Of Presence (POP) to generate global load balancing information obtained by calculating a hop and packet Internet groper response time between a user terminal and the POP using Internet Protocol (IP) address information of the user terminal;
a plurality of Server Load Balance (SLB) agents each provided in each service server located in the POP to collect server load balancing information including system resource information of the service server and information about the number of sessions for each port at regular intervals;
an Internet traffic management server for controlling and managing POPs distributed over a wide area, and searching for an optimal POP and an optimal service server using the global load balancing information and server load balancing information input through control of operation of the GLB agent and the SLB agent so as to establish an optimal connection path between the user terminal and the service server; and
the user terminal including a domain Database (DB) for storing domain information of the service server and IP information of the traffic management server controlling and managing the service server, and a client agent program for extracting domain information of the service server requested by a user and IP address information of a corresponding traffic management server and controlling a service server connection request signal including the extracted domain information to be transmitted to the traffic management server having the IP address information of the corresponding traffic management server over an Internet.

2. The intelligent traffic management system according to claim 1, wherein the POP is one of a collection of servers located in an Internet data center and a collection of servers located in a certain area.

3. The intelligent traffic management system according to claim 1, wherein the traffic management server comprises:
a GLB master for receiving the hops and the packet Internet groper response times, which are the global load balancing information, generated by controlling the GLB agents to be operated through transmission of the service server connection request signal, comparing and analyzing the hops and the packet Internet groper response times, and selecting the optimal POP;
a SLB master for receiving the system resource information and secession information of service servers, which are the server load balancing information, collected by controlling the SLB agents of the service servers to be operated through transmission of the service server connection request signals, comparing and analyzing the system resource information and secession information, and selecting the optimal service server;
a communication module for performing an interface function to enable data transmission/reception between the servers and the agents;
a Database (DB) for storing fixed IP block information about the optimal POP matched with the user terminal preset by a system manager, domain and IP information of the service server requested by the user, optimal global load balancing information including server connection request time information about time when the user requests connection to the service server and the IP address information of the user terminal, and values obtained by calculating the hop and the packet Internet groper response time between the user terminal and the optimal POP, and server load balancing information of each service server located in each POP; and
a control unit for controlling operations of the GLB master and SLB master.

4. The intelligent traffic management system according to claim 1, wherein the server load balancing information stored in the DB is updated by service load balancing information automatically transmitted from each service server provided with the SLB agent located in each POP at regular intervals.

5. The intelligent traffic management system according to claim 1, further comprising a user terminal that is not provided with the client agent program.

6. The intelligent traffic management system according to claim 1, further comprising a Domain Name Server (DNS) for storing the IP address information of the traffic management server,
wherein, when the service server connection request signal is transmitted from the user terminal not provided with the client agent program to the DNS, the DNS adds IP address information thereof to the service server connection request signal, and transmits the service server connection request signal together with the IP address information of the DNS.

7. The intelligent traffic management system according to claim 6, wherein the service server connection request signal transmitted from the user terminal not provided with the client agent program to the DNS comprises domain information of the service server requested by the user.

8. The intelligent traffic management system according to claim 1, wherein, when the user terminal not provided with the client agent program requests a connection path to the service server, the GLB agent generates the global load balancing information obtained by calculating the hop and the packet Internet groper response time between the user terminal and each POP using the IP address information of the DNS.

9. The intelligent traffic management system according to claim 3, wherein, when the user terminal not provided with the client agent program requests a connection path to the service server, the DB stores the fixed IP block information about the optimal POP matched with the user terminal preset by a system manager, the domain and IP information of the service server requested by the user, the optimal global load balancing information including server connection request time information about the time when the user requests connection to the service server and the IP address information of the user terminal, and the values obtained by calculating the hop and the packet Internet groper response time between the user terminal and the optimal POP, and the server load balancing information of each service server located in each POP.

10. The intelligent traffic management system according to claim 1, wherein the system resource information contained in the server load balancing information is information about the Central Processing Unit (CPU) and memory of the service server.

11. An intelligent traffic management method, comprising the steps of:
running a web browser installed on a user terminal to connect the user terminal to a service server through an optimal connection path;
determining whether a client agent program is installed;
if the client agent program is installed, extracting domain name information of the requested service server, IP address information of a corresponding traffic management server managing and controlling the service server, and IP address information of the user terminal;
transmitting a service server connection request signal including the extracted information to the corresponding traffic management server;
determining whether the user terminal corresponds to a fixed IP block set by a system manager;
if the user terminal does not correspond to the fixed IP block, determining whether global balancing information matched with the IP address of the user terminal exists;
if the global balancing information exists, selecting an optimal POP using the global balancing information;
searching for an optimal one of service servers located in the selected optimal POP; and
assigning an optimal connection path by transmitting the IP address of the searched optimal service server to the user terminal.

12. The intelligent traffic management method according to claim 11, further comprising the step of, if the user terminal corresponds to the fixed IP block at the step of determining whether the user terminal corresponds to the fixed IP block, extracting a previously set optimal POP.

13. The intelligent traffic management method according to claim 11, wherein, at the step of determining whether the user terminal corresponds to the fixed IP block, the fixed IP block is one of IP addresses of service servers used by an Internet Service Provider (ISP) at which the user has registered to use a Internet service and IP addresses of servers located in an Internet data center for each area.

14. The intelligent traffic management method according to claim 11, wherein, at the step of determining whether the global load balancing information matching the IP address information of the user terminal exists, the IP address of the user terminal is used to determine whether the global load balancing information exists through matching with the server connection request time information stored in the DB of the traffic management server.

15. The intelligent traffic management method according to claim 11, wherein, at the step of searching for an optimal one of service servers located in the selected optimal POP, the searching for the optimal service server is performed by comparing and analyzing server load balancing information comprising system resource information including information about the CPU and memory of each service server and information about the number of sessions for each port in the server load balancing information of the service servers located in each POP, which is stored in the DB of the traffic management server, searching for one service server having optimal service load balancing information, and selecting the service server having an optimal connection path to the user terminal.

16. The intelligent traffic management method according to claim 11, wherein the step of selecting an optimal POP using the global balancing information comprises the steps of:
reading recent connection time when the user requests connection to the service server;
determining whether an available period of the global balancing information is terminated;
if the available period of the global balancing information is terminated, extracting an optimal POP by controlling the GLB agent.

17. The intelligent traffic management method according to claim 16, further comprising the step of, if the available period of the global balancing information is not terminated at step, selecting global load balancing information indicating the optimal POP.

18. The intelligent traffic management method according to claim 17, wherein the step of extracting an optimal POP by controlling the GLB agent comprises the steps of:
transmitting IP address information of the user terminal from the traffic management server to a GLB agent dedicated server provided with the GLB agent in each POP;
generating new global load balancing information obtained by calculating a hop and packet Internet groper response time between the user terminal and the POP using the transmitted IP address information of the user terminal and transmitting the new global load balancing information; and
comparing and analyzing plural pieces of new global load balancing information transmitted from respective POPs, and selecting and storing an optimal POP.

19. The intelligent traffic management method according to claim 18, wherein, at the step of comparing and analyzing plural pieces of new global load balancing information transmitted from respective POPs, and selecting and storing an optimal POP, server connection request time information including time when the user requests connection to a corresponding service server and the IP address information of the corresponding user terminal is attached to the new global load balancing information and the new global load balancing information together with server connection request time information is stored in the DB.

20. The intelligent traffic management method according to claim 11, if the client agent program is not installed on the user terminal at the step of determining whether the client agent program is installed on the user terminal, further comprising the steps of:
extracting domain name information of a service server requested by the user terminal on which the client agent program is not installed;
transmitting the extracted domain name information of the service server to the DNS;
determining whether the DNS has IP address information of the traffic management server; and
if the DNS has the IP address information of the traffic management server, transmitting the server connection request signal in which the IP address information address of the DNS is attached to the domain name information of the service server to the traffic management server.

21. The intelligent traffic management method according to claim 11, wherein, at the step of determining whether the user terminal corresponds to the fixed IP block set by the system manager, it is determined whether the user terminal corresponds to the fixed IP block using one of the IP address information of the user terminal and the IP address information of the DNS.

22. The intelligent traffic management method according to claim 11, wherein, at the step of, if the user terminal does not correspond to the fixed IP block, determining whether global balancing information matched with the IP address of the user terminal exists, if the user terminal not provided with the client agent program requests connection to a service server, it is determined whether the global load balancing information exists by matching with the IP address information of the corresponding DNS.

23. The intelligent traffic management method according to claim 22, wherein the IP address information of the DNS is used to determine whether the global load balancing information exists through matching with the server connection request time information stored in the DB of the traffic management server.

24. The intelligent traffic management method according to claim 11, wherein, at the step of searching for the optimal one of service servers located in the selected optimal POP, if the user terminal not provided with the client agent program requests connection to the service server, the searching for the optimal service server is performed by comparing and analyzing the server load balancing information comprising the system resource information including information about the CPU and memory of each service server and information about the number of sessions for each port in the server load balancing information of the service servers located in each POP, which is stored in the DB of the traffic management server, searching for one service server having optimal service load balancing information, and selecting the service server having an optimal connection path to the user terminal.

25. The intelligent traffic management method according to claim 17, wherein, at the step of generating new global load balancing information obtained by calculating a hop and packet Internet groper response time between the user terminal and the POP using the transmitted IP address information of the user terminal and transmitting the new global load balancing information, if the user terminal not provided with the client agent program requests connection to the service server, the new global load balancing information obtained by calculating the hop and the packet Internet groper response time between the user terminal and each POP using the IP address information of the DNS is generated.

26. The intelligent traffic management method according to claim 18, wherein, at the step of comparing and analyzing plural pieces of new global load balancing information transmitted from respective POPs and selecting and storing an optimal POP, if the user terminal not provided with the client agent program requests connection to the service server, the server connection request time information including time when the user requests connection to a corresponding service server and the IP address information of the corresponding DNS is attached to the new global load balancing information and the new global load balancing information together with server connection request time information is stored in the DB.

27. An intelligent traffic management method, comprising the steps of: running a web browser installed on a user terminal to connect the user terminal to a service server through an optimal connection path when the service server requested by a user is located in a single POP;
determining whether a client agent program is installed;
if the client agent program is installed, extracting domain name information of the requested service server, IP address information of a corresponding traffic management server managing and controlling the requested service server, and IP address information of the user terminal;
transmitting a service server connection request signal including the extracted information to the corresponding traffic management server;
determining whether the service server requested by the user is located in the single POP;
if the service server requested by the user is located in the single POP, searching for an optimal service server in the corresponding POP; and
assigning an optimal connection path by transmitting the IP address of the searched optimal service server to the user terminal.
